(19) United States
(12) Patent Application Publication
(10) Pub. No.: US 2006/0102451 A1
(43) Pub. Date: May 18, 2006

(54) Conveyor roller and a process for making it

(75) Inventor: Roberto Gamberini, Bologna (IT)

Correspondence Address: YOUNG & THOMPSON, 745 SOUTH 23RD STREET, 2ND FLOOR, ARLINGTON, VA, 22202, US

(73) Assignee: DUGOMRULLI S.R.L., ZOLA PREDOSA (BOLOGNA) (IT)

(21) Appl. No.: 11/072,231

(22) Filed: Mar. 7, 2005

(30) Foreign Application Priority Data
Mar. 9, 2004 (IT) BO2004A000132

(51) Int. Cl. B65G 7/04

(52) U.S. Cl. 198/780

(57) ABSTRACT

Described is a roller (10) for conveying items along a predetermined path in an industrial installation. The roller (10) comprises fixed means for supporting it, rotatable supporting means in the form of a tubular element (13) and means for feeding the items, in the form of respective lateral sleeves (12, 14). The roller further comprises means for driving it, in the form of a sprocket or pulley, and means for supporting said roller drive means. Suitable means are also provided for joining the means that support the drive means to the tubular element constituting the rotatable supporting means, said joining means being provided at a lateral end of the roller (10).

### BACKGROUND OF THE INVENTION

This invention relates to a roller for conveying items or parts along a predetermined path in an industrial installation.

Prior art rollers for conveying items along a predetermined path in an industrial installation comprise fixed supporting means, in particular consisting of a fixed shaft or bar, rotatable roller supporting means, in particular consisting of a tubular element coaxial with said shaft, means for feeding the items or parts to be conveyed and means for rotationally driving the roller, in particular consisting of a pulley or sprocket mounted, through intermediate supporting means, on the rotatable tubular element.

In the known rollers of this type, means are provided for joining the supporting means to the roller drive means. The joining means consist of a circumferential seam weld or bead made between a transversal edge of the means for supporting the pulley or sprocket and a corresponding surface portion of the rotatable tubular supporting element. More specifically, the weld between the means for supporting the drive means and the rotatable tubular supporting element is made at a central or internal area of the roller.

One disadvantage of rollers of this type, which operate at high speeds and are subjected to high working loads, is the breakage of the rotatable tubular supporting element, which usually occurs, probably on account of “fatigue”, precisely at the weld joining the means for supporting the drive means (pulley or sprocket) to the rotatable tubular supporting element.

### SUMMARY OF THE INVENTION

It has been provided a roller for conveying items along a predetermined path in an industrial installation; said roller comprising fixed roller supporting means, rotatable roller supporting means in the form of a suitable tubular element, means for driving the roller and means for supporting the roller drive means; means also being provided for joining to the roller the means that support the drive means; wherein the means for joining the means that support the drive means are made at a lateral end of the roller.

In a roller according to the invention, breakage of the rotatable supporting element is avoided because there is significantly less operating stress at the join between the means that support the drive means and the rotatable supporting means, thus practically eliminating the risk of breakage due to fatigue of the corresponding roller element.

Furthermore, a join of this kind facilitates the process for making the roller.

The invention also relates to an advantageous process for making the roller.

The other claims relate to other advantageous aspects of the roller according to the invention.

### BRIEF DESCRIPTION OF THE DRAWINGS

The technical characteristics and advantageous aspects of the invention will become more apparent from the detailed description which follows, with reference to the accompanying drawings which illustrate preferred embodiments of the invention provided merely by way of example without restricting the scope of the inventive concept, and in which:

FIG. 1A is a schematic cross section of a first preferred embodiment of a roller according to the present invention;

FIG. 1B is an enlarged detail of the embodiment of FIG. 1A;

FIG. 2A is a schematic cross section of a second preferred embodiment of a roller according to the present invention;

FIG. 2B is an enlarged detail of the embodiment of FIG. 2A;

FIG. 3 is a schematic cross section of a third preferred embodiment of a roller according to the present invention;

FIG. 4 is a schematic cross section of a fourth preferred embodiment of a roller according to the present invention;

FIG. 5 is a schematic cross section of a fifth preferred embodiment of a roller according to the present invention;

FIGS. 6 to 10 schematically illustrate a succession of steps of a preferred embodiment of the process according to the invention;

FIG. 11 is a schematic cross section of a sixth preferred embodiment of a roller according to the present invention;

FIG. 12 is a schematic cross section of a seventh preferred embodiment of a roller according to the present invention.

### DESCRIPTION OF THE PREFERRED EMBODIMENTS

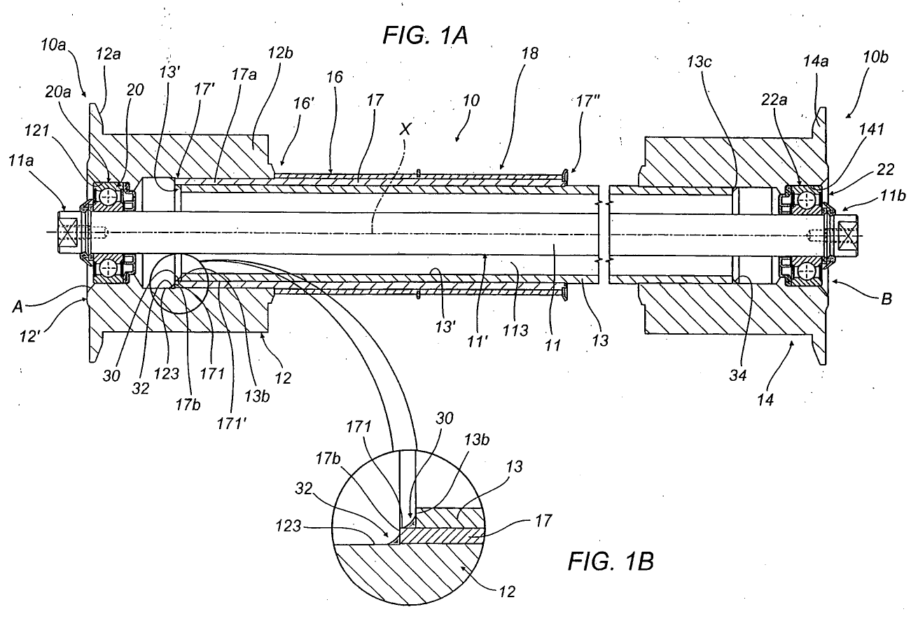

Illustrated in FIGS. 1A and 1B is a first preferred embodiment of a roller 10, according to the present invention, for conveying items along a predetermined path in an industrial installation. During use, the roller turns about an axis labeled “X” in FIG. 1A.

The items consist, in particular, of parts, especially automotive parts weighing between 300 and 2000 kg. The parts are preferably mounted on supporting carriages or slides travelling at a speed of up to 160 m/min and over, along a predetermined path in an industrial installation. Obviously, the path is defined by a plurality of said conveyor rollers positioned one after the other.

The roller 10 comprises fixed means for supporting it. The means for supporting the roller 10 comprise a fixed transversal bar or shaft 11, having opposite supporting ends 11a, 11b fitted in respective lateral seats (not illustrated in the accompanying drawings), on the frame or channel defining the part conveying path in a known manner well within the knowledge of an expert in the trade.

As illustrate, the roller also comprises rotatable supporting means. In particular, the means for rotatably supporting the roller comprise a tubular element 13 that extends in a transversal space between the opposite ends 10a, 10b of the roller and is mounted coaxially on the outside of the fixed shaft 11. The tubular element 13 has a cylindrical inside surface 13′ that is radially spaced from the outside surface 11′ of the fixed shaft 11, defining an empty circumferential space 113.

As illustrated, means are also provided for connecting the rotatable supporting means 13 in a freely rotatable manner to the fixed means 11 for supporting the roller.

The freely rotatable connecting means comprise a first and a second rolling bearing 20, 22 located at the lateral ends of the roller and connecting the fixed means 11 to the rotatable means 13 through respective lateral sleeves 12, 14, constituting the means for feeding the parts, as described in more detail below.

As illustrated, the roller 10 is also equipped with working means. The working means of the roller 10 comprise means for feeding the items to be conveyed, said feed means comprising, as mentioned above, a first and a second sleeve 12, 14 extending at opposite lateral ends of the roller and defining means for engaging the parts to be conveyed or the respective part supports.

More specifically, the sleeves 12, 14 have respective containment flanges 12a, 14a, each extending radially at one of the lateral end sections of the roller 10, or of the sleeve itself. It will be understood, however, that the lateral containment flanges might be substituted and their lateral containment function performed by equivalent elements outside the roller, that is to say, forming part of the path or channel that accommodates the rollers themselves.

As shown in the drawings, the sleeves 12, 14 are mounted coaxially with respect to the shaft 11 at the latter's opposite ends 10a, 10b, and with the lateral bearings 20, 22 interposed between them. For this purpose, each of the sleeves 12, 14 has a respective annular inside surface 121, 141 for fixedly engaging with an outside surface 20a, 22a of the respective bearing 20, 22. As illustrated, the annular inside engagement surface 121, 141 of each sleeve is located at a circumferential, radially recessed portion of the sleeve 12, 14 itself.

The working means of the roller 10 also comprise means for rotationally driving the roller. The roller drive means comprise at least one drive element or, more specifically, in this case, a first and a second drive element 16, 18 enabling the conveyed items to be moved forwards and backwards, respectively.

As illustrated, in this preferred embodiment, each drive element 16, 18 is a pulley. Each drive element might, however, also consist of a sprocket or other equivalent rotational drive element.

Means are also provided for supporting the roller drive means.

The means for supporting the roller drive means comprise a tubular portion 17 fixed to the rotatable tubular supporting element. In particular, the tubular portion 17 is keyed to the rotatable tubular supporting element 13. The portion 17 might, however, also be fixed to the tubular element in any other suitable manner.

As illustrated, the tubular portion 17, which constitutes an interposing element between the rotatable tubular supporting element 13 and the rotational drive means 16, 18, has an advantageous extension 17a extending towards the respective end 10a of the roller 10 and past the respective lateral end 16′ of the drive means.

The tubular portion 17 also has a first and a second lateral or axial end 17′, 17″ facing the respective opposite ends 10a, 10b of the roller 10.

Looking in more detail, the axial extension 17a of the tubular portion 17 extends under a portion 12b of the sleeve, facing the inside or central part of the roller.

Advantageously, the axial extension 17a also extends in the region of the end 10a of the roller 10 and, more specifically, in the vicinity of the respective bearing 20.

As illustrated, in this embodiment of the roller, the axial extension 17a of the tubular portion 17 extends under the lateral sleeve 12 and is inserted between an inside cylindrical surface of the sleeve 12 and a corresponding outside surface portion of the tubular element 13.

In particular, as illustrated, the end 17′ of the element that supports the drive means extends laterally or axially past the respective edge or lateral end 13′ of the rotatable tubular supporting element 13 of the roller 10.

As illustrated, means are provided for connecting in a freely rotatable manner the fixed supporting means 11 to the drive or feed means 16, 18, defined by the fixed connection between the sleeves and the bearings and the connection between the bearings and the ends of the fixed shaft 11.

Means are also provided for joining the means 17 that support the drive means. The means for joining the means that support the drive means are embodied by a weld advantageously provided at a lateral end 10a of the roller 10.

As illustrated, the means for joining the means 17 that support the drive means 16, 18 comprise, in particular, a circumferential seam weld or bead 32 made in the vicinity of a lateral end 10a of the roller 10.

In particular, the means 32 for joining the means that support the drive means are provided at an end 17′ of the extension 17a of the means that support the drive means, said end being the one facing or located at a respective end 10a of the roller 10.

More specifically, the joining means 32 are provided between the means that support the drive means and the working means or lateral sleeve 12.

As illustrated, the joining means 32 are provided between a transversal edge 17b, at the end 17′ of the cylindrical extension 17a of the pulley supporting means and a corresponding annular portion or zone 123 of the inside surface of the sleeve 12. This annular zone 123 is located in the vicinity of the line through the center of the respective sleeve 12, more towards the lateral end section of the latter.

Additional joining means, consisting of a respective weld, are provided between the tubular element 13 and the supporting portion 17 of the drive means.

The second weld comprises a circumferential bead 30 made between a transversal edge 13b, at the end 13′ of the rotatable supporting element 13 and a circumferential portion or zone 171 of the inside surface 171′ of the supporting portion 17 of the drive means 16, 18. In particular, as illustrated, the circumferential portion or zone 171 is located at the end of the inside surface 171′.

Additional joining means between the rotatable tubular supporting element 13 and the feed sleeves 12, 14 are provided at the opposite end 10b of the roller and comprise a third circumferential seam weld 34 made between an opposite lateral edge 13c of the roller 10 and a respective circumferential inside surface of the feed sleeve 14.

This roller configuration, with the means for joining the rotatable supporting means made in the vicinity of the lateral end of the roller, reduces the stress on the joining means themselves, thereby improving the resistance and life of the roller.

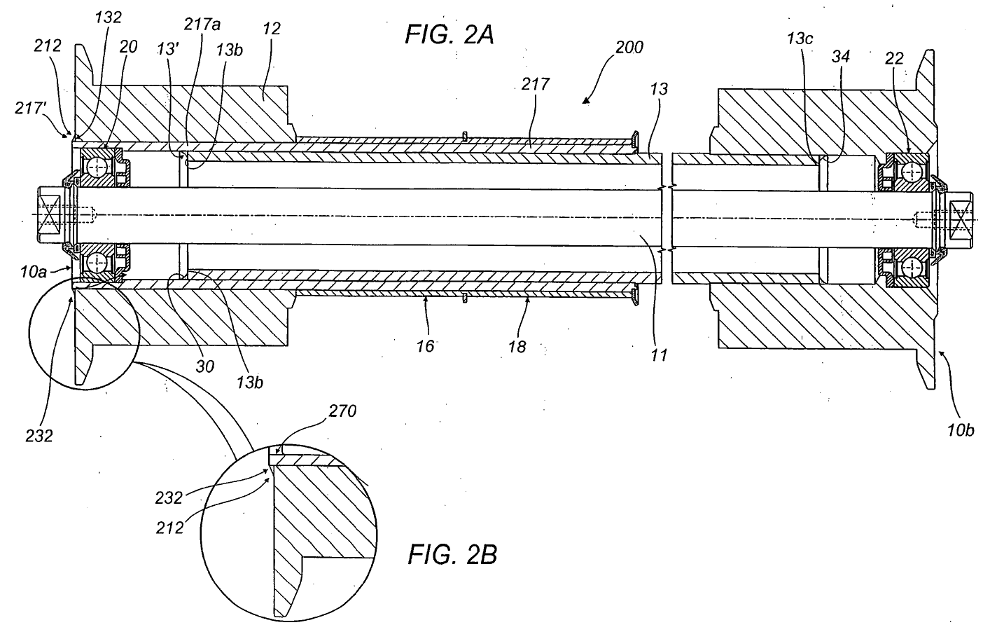

FIGS. 2A and 2B illustrate a second advantageous embodiment 200 of the roller according to the invention. The parts of the second preferred embodiment that are similar to those of the first preferred embodiment are indicated by the same reference numerals as those used in FIGS. 1A and 1B and will not be described in detail again.

With reference to FIG. 2A, the above mentioned axial extension 117a extends in the vicinity of the lateral support bearing 20.

Indeed, the axial extension 217a of the means 217 that support the drive means or pulleys 16 and 18 extends in the vicinity of the end 10a, above (or transversely to) and past the support bearing 20 and the end of the extension 217a is positioned on the outer side of the bearing 20.

Thus, the intermediate supporting element 217 directly defines means for rotatably connecting the drive means 16, 18 to the fixed support means 11 through the bearing 20.

The intermediate supporting element 217 also defines means for supporting the respective working means or sleeve 12.

The joining means 232 are provided between an outer transversal edge 212 of the sleeve 12 and a corresponding annular portion 270 of the outside surface of the tubular portion 217 at the end 217′ of the extension 217a.

In particular, as illustrated, the joining means 132 are provided at the transversal end face of the roller 200.

Thus, there is even less stress on the seam weld 232. The risk of fatigue failure is significantly reduced.

Moreover, the weld is particularly easy to make.

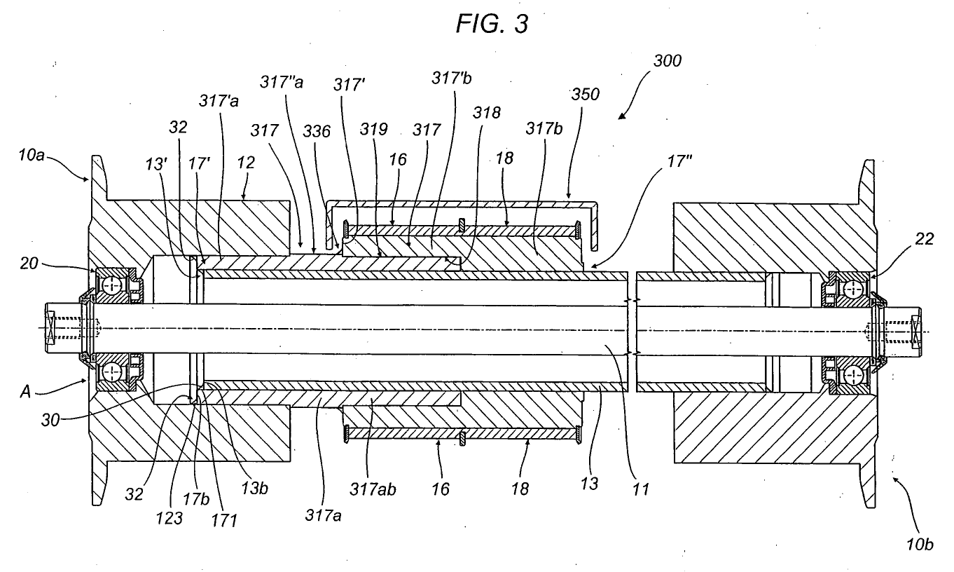

FIG. 3 illustrates a third preferred embodiment 300 of the roller according to the invention.

The parts of the third preferred embodiment that are similar to those of the first preferred embodiment are indicated by the same reference numerals as those used in FIG. 1A and will not be described in detail again.

The third preferred embodiment differs from the first embodiment in that the rotatable tubular supporting element 317 consists of two coaxial, transversely aligned portions 317a and 317b. In particular, the first portion 317a extends from the end 10a of the roller towards the end 10b and is partly inserted into the second portion 317b.

More specifically, the first portion 317a of the tubular element has a lateral end section 317′a that is narrower in diameter than its central section 317″a so that the outer end section 317′a is recessed and defines means for insertion into a respective portion of the sleeve 12. The reference 317ab denotes an end section opposite the first portion 317′a of the tubular element. This section 317ab transversely faces the inside of the roller and is also narrower in diameter in such a way as to define a recessed outside surface 319 for coupling with a matching cylindrical inside surface 218 of an end section 317′b, transversely facing the inside of the roller, of the second portion 317b of the tubular element.

The second portion 317b keeps the roller drive means away from the lateral sleeve 12. In addition to the joining means 30 and 32 of the first preferred embodiment, there are additional joining means comprising a fourth seam weld 336 made between a lateral edge 317′ of the second portion 317b and a respective outside circumferential surface of the intermediate portion 317′a of the supporting element 317a.

In particular, in the third embodiment, the weld 32 is made between the end 17′ of the first portion 317a of the tubular element and the respective inside surface of the sleeve 12.

The roller 10 also has a protective guard 350 positioned at the drive means and secured to the roller in known manner.

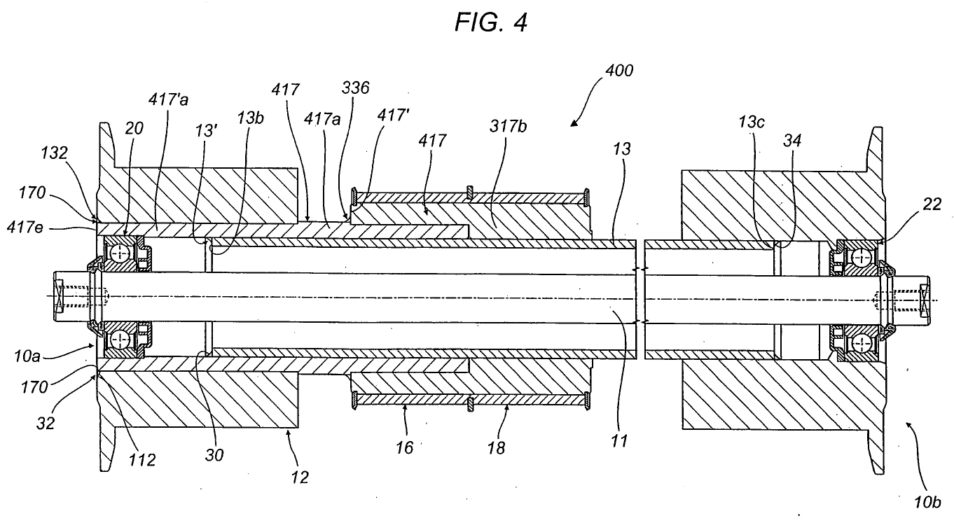

FIG. 4 illustrates a fourth preferred embodiment 400 of the roller according to the invention.

The parts of the fourth preferred embodiment that are similar to those of the preferred embodiments described above are indicated by the same reference numerals and will not be described in detail again.

The fourth preferred embodiment, like the third preferred embodiment, has a tubular supporting element 417 consisting of a first and a second portion 417a, 317b.

Compared to the embodiment illustrated in FIG. 3, the axial extension 417′a of the first portion 217a extends in the region of the respective lateral support bearing 20, in much the same way as in the second preferred embodiment described above.

Indeed, the axial extension 417′a extends in the vicinity of the end 10a, above (or transversely to) and past the support bearing 20 and the end of the extension 417e is positioned on the outer side of the bearing 20.

Thus, the portion 417′a of the intermediate supporting element 417 directly defines means for rotatably connecting the drive means 16, 18 to the fixed support means 11 through the bearing 20.

The portion 417′a of the intermediate supporting element 417 also defines means for supporting the respective working means or sleeve 12.

As in the second preferred embodiment described above, the joining means 132 are provided between an outer transversal edge 112 of the sleeve 12 and a corresponding annular portion 470 of the outside surface of the tubular portion 417′ at the latter's lateral end 417e.

The two-part means for supporting the pulley or equivalent drive means in the fourth and third preferred embodiments are easier to assemble since each of the two parts weighs less than the single supporting element of the other embodiments.

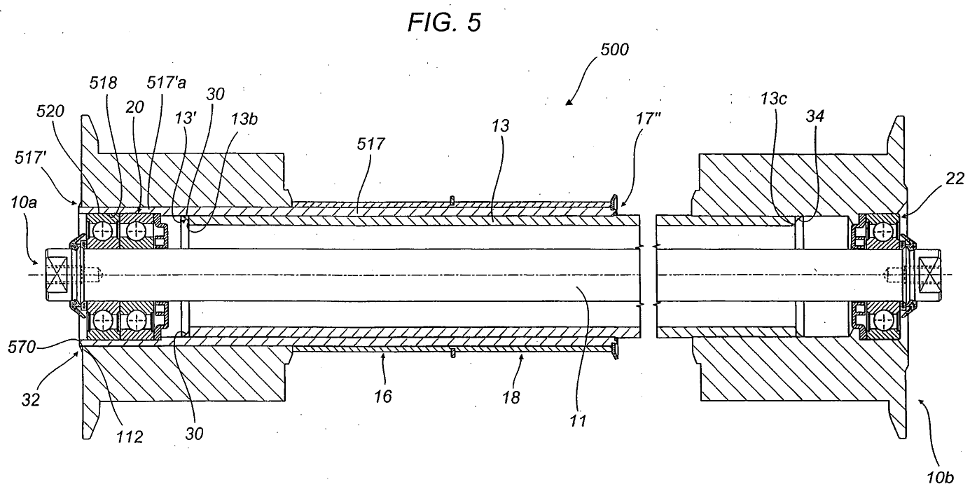

A fifth preferred embodiment 500 is illustrated in FIG. 5. The parts of the fifth preferred embodiment that are similar to those of the preferred embodiments described above are indicated by the same reference numerals and will not be described in detail again.

As may be seen in FIG. 5, the freely rotatable connecting means between the rotatable supporting means 13 and the fixed supporting means 11 of the roller comprise a third rolling bearing 520 positioned next to the bearing 20 and fitted around the shaft 11.

In the fifth preferred embodiment, the axial extension 517′a of the tubular element 517 extends, as mentioned above, in the vicinity of the end 10a, above the support bearings 20 and 520.

In particular, the axial extension 517′a of the tubular element 517 has an inside end surface 518 which is larger in diameter, that is, wider in the transversal direction, in order to accommodate and be coupled with the outside surface of the pair of bearings 20, 520.

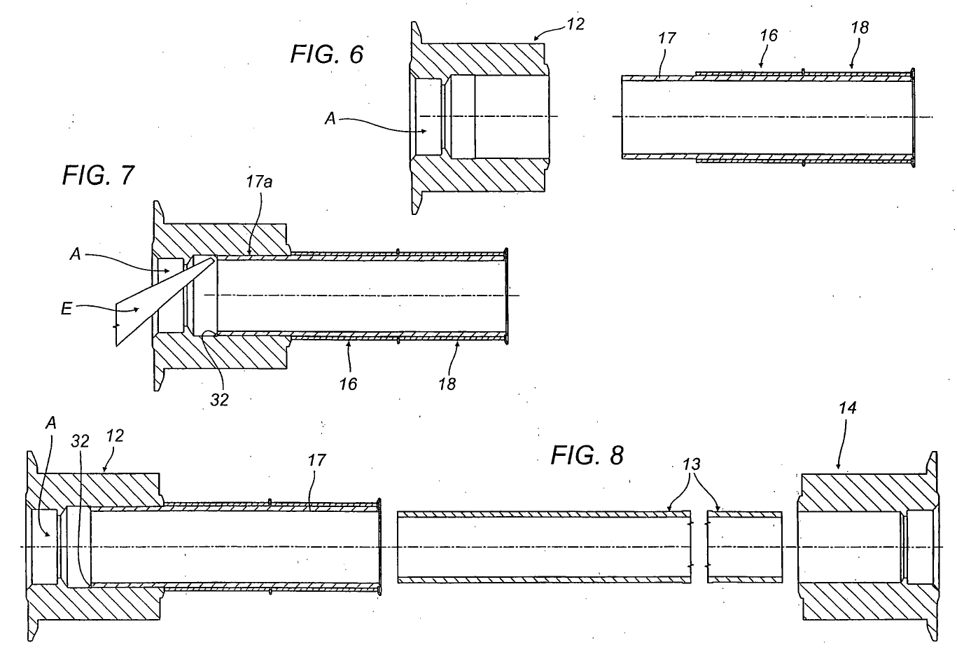

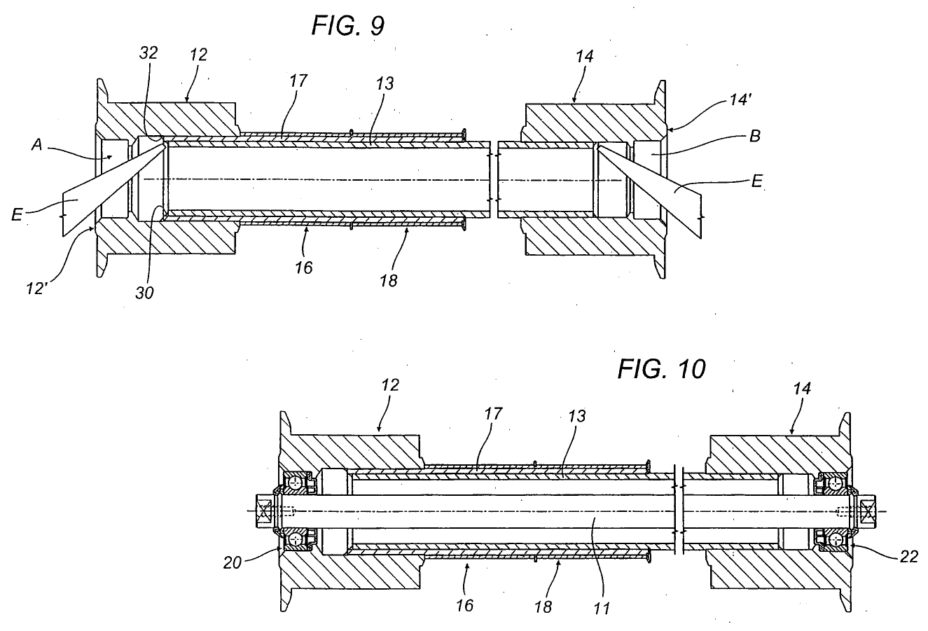

FIGS. 6 to 10 schematically illustrate a succession of steps in a preferred process for assembling the roller according to the invention.

With the joining means described above, the tubular element 13 is not, as in prior art, welded directly to the inside surface of the sleeve 12 and the tubular portion 17 for supporting the pulleys 16 and 18 then welded to the outside of the rotatable tubular supporting element 13.

Instead, in the roller 10 according to this invention, the connection between the rotatable tubular element 13 and the end sleeve 12 is accomplished with the aid of the extension 17a of the tubular portion 17 that supports the pulleys, that is to say, by welding the extension 17a to the inside of the sleeve 12 then welding the rotatable tubular element 13 to the extension 17a of the tubular portion that supports the pulleys. The finished roller, after further machining operations, is illustrated in FIG. 10.

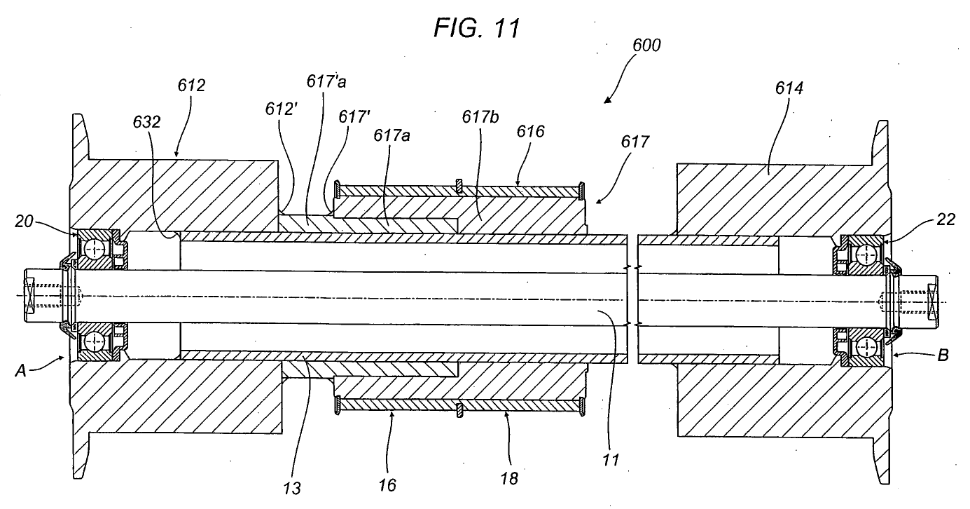

FIG. 11 illustrates a sixth preferred embodiment 600 of the roller according to the invention.

The parts of the sixth preferred embodiment that are similar to those of the preferred embodiments described above are indicated by the same reference numerals and will not be described in detail again.

In the sixth preferred embodiment, as in the third and fourth preferred embodiments, the tubular element 617 that supports the drive means 616 consists of a first and a second portion 617a, 617b.

Compared to the arrangement of FIGS. 3 and 4, however, the axial extension 617′a of the first portion 617a is relatively short and extends only as far as the opposing side of the working element or sleeve 612 to which it is joined by suitable joining means consisting of a circumferential seam weld 612′.

Additional joining means 617′ are provided between the outer transversal edge of the pulley 616 and the first portion 617 of the supporting means.

In the sixth embodiment, there are joining means between the inside tubular element 13 and the working sleeves 612 and 614. In particular, the means for joining to the sleeve 612 comprise a weld in the form of a circumferential seam weld 612 between a transversal end edge of the tubular element 13 and a respective circumferential zone of the cylindrical inside surface of the sleeve 612.

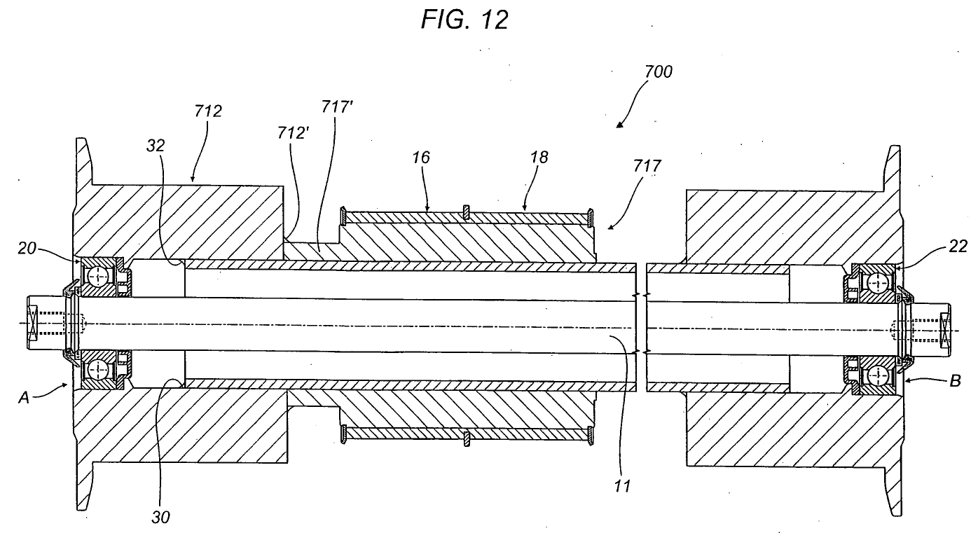

FIG. 12 illustrates a seventh preferred embodiment 700 of the roller according to the invention.

The parts of the seventh preferred embodiment that are similar to those of the preferred embodiments described above are indicated by the same reference numerals and will not be described in detail again.

The tubular supporting element 717 of the seventh preferred embodiment is made as a single piece and its axial extension 717′ is relatively short, extending only as far as the opposing side of the working element or sleeve 712 to which it is joined by suitable joining means consisting, in particular, of a circumferential seam weld 712′.

As mentioned, the present invention also relates to a process for making the roller described above.

In the advantageous process according to the invention, the weld 30 and, if necessary, the weld 32, for joining the rotatable tubular supporting element 13 to the working sleeve 12 can be made through an opening A at the end of the sleeve 12.

In this embodiment of the assembly procedure, in particular for making a roller according to the first preferred embodiment, the tubular element 17 with the drive means is inserted into the sleeve 12, and the tubular portion 17 is then welded to the sleeve 12 (weld 32).

Next, the rotatable tubular supporting element 13 is inserted into and welded to the tubular portion 17 itself (weld 30).

Again, the weld 30 is made through the opening A defined by the circular inside surface of the sleeve 12.

In substantially the same way, the weld 34 between the sleeve 14 and the tubular element 13 is made through the opening B defined by the circular inside surface of the sleeve 14.

The distances at which the welds 30, 32 are made from the end face 12′ of the sleeve 12 and the distance at which the weld 34 is made from the outside face 14′ of the sleeve 14 are predetermined in such a way that the welds 30, 32 and 34 can be reached by a welding tip E of the welding machine (not illustrated).

Thus, welding operations for making the seam welds 30, 32 and 34 can be performed using a single welding machine working on a single roller assembly line, thus saving considerable time and money on assembly.

Lastly, the supporting shaft 11 is inserted and the bearings 20 and 22 fitted.

The invention, as disclosed above, can be modified and adapted in several ways without thereby departing from the scope of the inventive concept.

Moreover, all the details of the invention may be substituted by technically equivalent elements.

What is claimed is:

1. A roller (10) for conveying items along a predetermined path in an industrial installation; said roller comprising fixed roller (10) supporting means (11), rotatable roller (10) supporting means in the form of a suitable tubular element (13), means (16, 18) for driving the roller (10) and means (17) for supporting the roller drive means (16, 18); means also being provided for joining to the roller the means (16) that support the drive means; wherein the means for joining the means (17) that support the drive means (16,18) are made at a lateral end (10a) of the roller (10).

2. The roller (10) according to claim 1, wherein the fixed means for supporting the roller (10) comprise a shaft (11).

3. The roller (10) according to claim 1, comprising means (20, 520, 22) for connecting in a freely rotatable manner the rotatable supporting means (13) of the roller (10) to the fixed supporting means (11) of the roller (10).

4. The roller (10) according to claim 1, wherein the means for feeding the conveyed items comprise at least one sleeve (12, 14) constituting means for engaging the conveyed items.

5. The roller (10) according to claim 4, wherein the sleeve (12, 14) comprises an inside annular surface (121, 141) for securely engaging with an outside surface (20a, 22a) of the respective rolling bearing (20, 22).

6. The roller (10) according to claim 1, wherein the means for driving the roller (10) comprise at least one drive element (16).

7. The roller (10) according to claim 1, wherein the means for driving the roller (10) comprise a first and a second drive element (16, 18) for moving the conveyed items forwards and backwards, respectively.

8. The roller (10) according to claim 1, wherein each drive element (16, 18) consists of a pulley for a transmission belt.

9. The roller (10) according to claim 1, wherein each drive element consists of a sprocket for a transmission chain.

10. The roller (10) according to claim 1, wherein the means for supporting the roller (10) drive means comprise a tubular portion (17) which is fixed to the rotatable tubular supporting element (13).

11. The roller (10) according to claim 10, wherein the tubular portion (17) is fixed to the rotatable tubular supporting element (13).

12. The roller (10) according to claim 10, wherein the tubular portion (17) has an axial extension (17a).

13. The roller (10) according to claim 12, wherein the axial extension (17a) extends in the vicinity of an end (10a) of the roller (10).

14. The roller (10) according to claim 10, wherein the axial extension (17a) of the tubular portion (17) extends under the sleeve (12, 14) for feeding the conveyed items.

15. The roller (10) according to claim 10, wherein the axial extension (17a) extends at the end (10a) of the roller (10).

16. The roller (10) according to claim 1, wherein the means for joining the means that support the drive means consist of a weld.

17. The roller (10) according to claim 1, wherein the means for joining the means that support the drive means consist of a circumferential weld (30).

18. The roller (10) according to claim 1, wherein the means (32) for joining the means (17) that support the drive means are made between the means that support the drive means and the feed means (12).

19. The roller (10) according to claim 1, wherein the joining means are made between the rotatable tubular supporting element and the means that support the drive means.

20. The roller (10) according to claim 1, wherein the circumferential weld (32) is made between a transversal edge (17b) of the tubular portion (17) that supports the drive means and an inside surface (123) of the feed means (12, 14).

21. The roller (10) according to claim 1, wherein the circumferential weld (32) is made between an outer transversal edge (112) of the drive means and a respective annular portion (170) of the outside surface of the tubular supporting portion (17).

22. The roller (10) according to claim 1, wherein the joining means (32) are provided between the feed means (12) and the extension (17a) of the means that support the drive means.

23. The roller (10) according to claim 1, wherein the joining means comprise a second joining portion (30) provided between the rotatable tubular supporting element (13) and the means (17) that support the drive means.

24. The roller (10) according to claim 23, wherein the second portion for joining the means that support the drive means consist of a weld.

25. The roller (10) according to claim 1, wherein the means for joining the means that support the drive means to the rotatable tubular supporting element (17) consist of a circumferential weld (30).

26. The roller (10) according to claim 1, any of the foregoing claims, wherein the circumferential weld (30) is made between a transversal end edge (13′) of the rotatable tubular supporting element (13) and an inside circumferential surface of the means (17) that support the drive means.

27. The roller (10) according to claim 1, wherein an additional weld (34) is provided at an opposite lateral end of the roller (10).

28. The roller (10) according to claim 1, wherein the distance at which the weld (30, 32) is made is such that the weld (30, 32) can be reached by a welding tip operating through an outer lateral opening (A) provided in the respective feed sleeve (12).

29. The roller (10) according to claim 1, wherein the supporting means (317) comprise a first and second portion (317a, 317b) coaxial with each other and forming a single tubular element (317).

30. The roller (10) according to claim 29, wherein the first portion (317a) extends from the lateral end (10a) of the roller towards an opposite end (10b) and is inserted into the second portion (317b).

31. The roller (10) according to claim 1, wherein the means for supporting the drive means have an axial extension (617′a) of the first portion (671a) extends as far as the opposing side of the working means or sleeve (612).

32. The roller (10) according to claim 31, comprising means for joining the axial extension (617′a) of the first portion (671a) to the working means or sleeve (612).

33. The roller (10) according to claim 31, comprising joining means (617′) between a transversal edge of the pulley (616) and the first extension (617′a) of the supporting means.

34. The roller (10) according to claim 1, wherein the means for supporting the drive means have supporting means (717) made as single part and having an axial extension (717′) extending as far as the opposing side of the working means or sleeve (712).

35. The roller (10) according to claim 34, comprising means for joining the axial extension (717′) of the supporting means to the working means or sleeve (712).

36. A process for assembling a roller, in particular a roller according to claim 1, wherein the weld for securing the means (17) that support the drive means to the rotatable tubular supporting element (13) is made by operating through an opening (A) at the end of the sleeve (12).

37. The process according to claim 36, wherein the weld for securing the rotatable tubular supporting element (13) to the working sleeve (12) is made by operating through the opening (A) at the end of the sleeve (12).

38. The process according to claim 36, comprising the steps of welding the tubular portion (17) to the sleeve (12) and of welding the rotatable tubular supporting element (13) to the tubular portion (17) itself.
